(19) United States
(12) Patent Application Publication
(10) Pub. No.: US 2024/0025379 A1
(43) Pub. Date: Jan. 25, 2024

(54) SERVICE TOOLS FOR VEHICLE BATTERY PACKS

(71) Applicant: FORD GLOBAL TECHNOLOGIES, LLC, Dearborn, MI (US)

(72) Inventors: Daniel Paul Roberts, Livonia, MI (US); Francisco Fernandez-Galindo, Canton, MI (US); Nihar Kotak, Ashburn, VA (US); Liam E. West, Ferndale, MI (US)

(21) Appl. No.: 17/867,748

(22) Filed: Jul. 19, 2022

(51) Int. Cl. B60S 5/06; H01M 50/249; H01M 50/264; H01M 10/42

(52) U.S. Cl. CPC B60S 5/06; H01M 50/249; H01M 50/264; H01M 10/4207; H01M 2220/20; H01M 50/209

(57) ABSTRACT

A service tool assembly according to an exemplary aspect of the present disclosure includes, among other things, a service tool that extends through an access hole in a floor of an electrified vehicle and is adapted to engage a threaded hole of a battery pack. The service tool is rotatable to translate the battery pack relative to the electrified vehicle.

### TECHNICAL FIELD

This disclosure relates to service tools and associated methods for removing and installing a battery pack of an electrified vehicle.

### BACKGROUND

Electrified vehicles include traction battery packs that power an electric motor and other electrical loads of the vehicle. Specialized equipment, such as a battery lifting jack, is typically needed to lower and raise battery packs of electrified vehicles for servicing and reinstallation.

### SUMMARY

A service tool assembly according to an exemplary aspect of the present disclosure includes, among other things, a service tool that extends through an access hole in a floor of an electrified vehicle and is adapted to engage a threaded hole of a battery pack. The service tool is rotatable to translate the battery pack relative to the electrified vehicle.

In a further non-limiting embodiment of the foregoing service tool assembly, the service tool includes a head that is integral with a threaded rod. The head is seated above the access hole and the threaded rod extends through the access hole and is received in the threaded hole of the battery pack.

In a further non-limiting embodiment of the foregoing service tool assembly, a thrust bearing is included. The thrust bearing sits on the floor on top of the access hole. The head sits on top of the thrust bearing and the threaded rod extends through the thrust bearing.

In a further non-limiting embodiment of the foregoing service tool assembly, the threaded rod extends a first distance past a bottom of the threaded hole. The first distance is greater than or equal to a second distance between the battery pack and a surface under the electrified vehicle.

In a further non-limiting embodiment of the foregoing service tool assembly, the threaded hole is disposed on a longitudinally extending side wall of a tray of the battery pack.

In a further non-limiting embodiment of the foregoing service tool assembly, the access hole is located in a passenger compartment of the electrified vehicle.

In a further non-limiting embodiment of the foregoing service tool assembly, the access hole is located on the floor in a foot space of one of a driver's seat and a front passenger seat.

In a further non-limiting embodiment of the foregoing service tool assembly, the access hole is located on the floor under a row of rear seats.

In a further non-limiting embodiment of the foregoing service tool assembly, a plurality of service tools extends through a plurality of access holes and are received in a plurality of threaded holes of the battery pack.

In a further non-limiting embodiment of the foregoing service tool assembly, the battery pack is supported on the electrified vehicle by the plurality of service tools alone.

In a further non-limiting embodiment of the foregoing service tool assembly, the plurality of service tools includes a uniform length.

In a further non-limiting embodiment of the foregoing service tool assembly, the plurality of access holes includes a first access hole at a first height above a second access hole. The plurality of threaded holes include a first threaded hole at a second height above a second threaded hole. The first height is less than or equal to the second height.

A method of translating a battery pack relative to an electrified vehicle according to an exemplary aspect of the present disclosure includes, among other things, inserting a service tool through an access hole of the electrified vehicle. A threaded hole of the battery pack is engaged with the service tool. The service tool is rotated, thereby translating the battery pack relative to the electrified vehicle.

In a further non-limiting embodiment of the foregoing method, fasteners securing the battery pack to the electrified vehicle are removed prior to translating.

In a further non-limiting embodiment of the foregoing method, a service disconnect is opened and an electrical harness and coolant conduit are detached from the battery pack prior to translating the battery pack.

In a further non-limiting embodiment of the foregoing method, an access cover covering the access hole is moved prior to inserting the service tool.

In a further non-limiting embodiment of the foregoing method, inserting the service tool includes inserting a plurality of service tools such that they extend through a plurality of access holes and are received in a plurality of threaded holes of the battery pack.

In a further non-limiting embodiment of the foregoing method, translating the battery pack includes alternatingly rotating each of the plurality of service tools.

In a further non-limiting embodiment of the foregoing method, translating the battery pack includes lowering the battery pack to rest on a surface. The service tools are removed from engagement with the battery pack after the step of translating.

In a further non-limiting embodiment of the foregoing method, the access hole extends through a floor of the electrified vehicle. The service tool includes a head, a threaded rod and a thrust bearing. The step of inserting includes inserting the service tool such that the thrust bearing sits on the floor above the access hole, the head sits on top of the thrust bearing, and the threaded rod extends through the thrust bearing and access hole and is received in the threaded hole.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a side view of an electrified vehicle.

FIG. 2 is a perspective view of a battery pack of the electrified vehicle of FIG. 1 with select portions removed in order to better illustrate and interior of the battery pack.

FIG. 3A is a section view of a service tool assembly for a battery pack in an installed position.

FIG. 3B is a section view of a service tool assembly of FIG. 3A in a lowered position.

FIG. 4A is section view of another example service tool assembly for a battery pack including a second tier row of battery arrays in an installed position.

FIG. 4B is a section view of the service tool assembly of FIG. 4A in a lowered position.

FIG. 5 schematically illustrates a method of servicing a battery pack of an electrified vehicle.

### DETAILED DESCRIPTION

This disclosure details service tools and methods for removing and installing a battery pack of an electrified vehicle. The service tool is inserted through an access hole in the floor of the vehicle and is received in a threaded hole of the battery pack. With all other battery attachment points removed, rotation of the service tool translates the battery pack relative to the electrified vehicle.

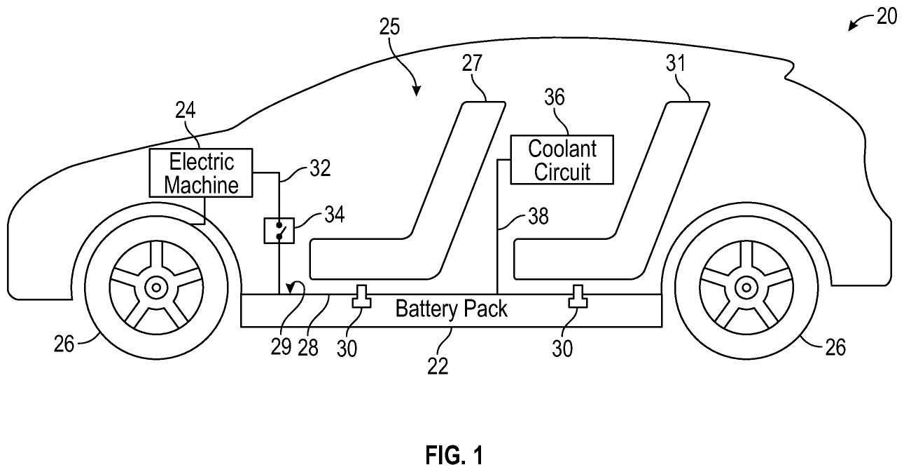

FIG. 1 illustrates an exemplary electrified vehicle 20 that includes a battery pack 22 that powers an electric machine 24 and other electrical loads of the electrified vehicle 20. The electrified vehicle includes a passenger compartment 25 and wheels 26 driven by the electric machine 24. The passenger compartment 25 may include front seats 27 with an associated foot space 29 and a row of rear seats 31. The electric machine 24 can receive electric power from the battery pack 22 and convert the electric power to torque to drive the wheels 26. The battery pack 22 may be a high-voltage traction battery pack.

The battery pack 22 is secured to an underbody 28 of the electrified vehicle 20, but could be located elsewhere in other examples. The battery pack 22 may be secured to the underbody 28 using mechanical fasteners 30.

An electrical harness 32 is coupled to the battery pack 22 and the electric machine 24. The battery pack 22 delivers power to the electric machine 24 through the electrical harness 32. A service disconnect 34 is included in the circuit to selectively connect the battery pack 22 to the electric machine 24. A user may open the service disconnect 34 to open the circuit between the battery pack 22 and electric machine 24 to prevent current flow from the battery pack 22 through the electrical harness 32 to the electric machine 24. A coolant circuit 36 may circulate coolant to the battery pack 22 through coolant conduits 38, which may be flexible hoses. The coolant circulated by the coolant circuit 36 may thermally manage the battery pack 22.

The electrified vehicle 20 is an all-electric vehicle. In other examples, the electrified vehicle 20 is a hybrid electric vehicle, which selectively drives wheels 26 using torque provided by an internal combustion engine instead of, or in addition to, the electric machine 24.

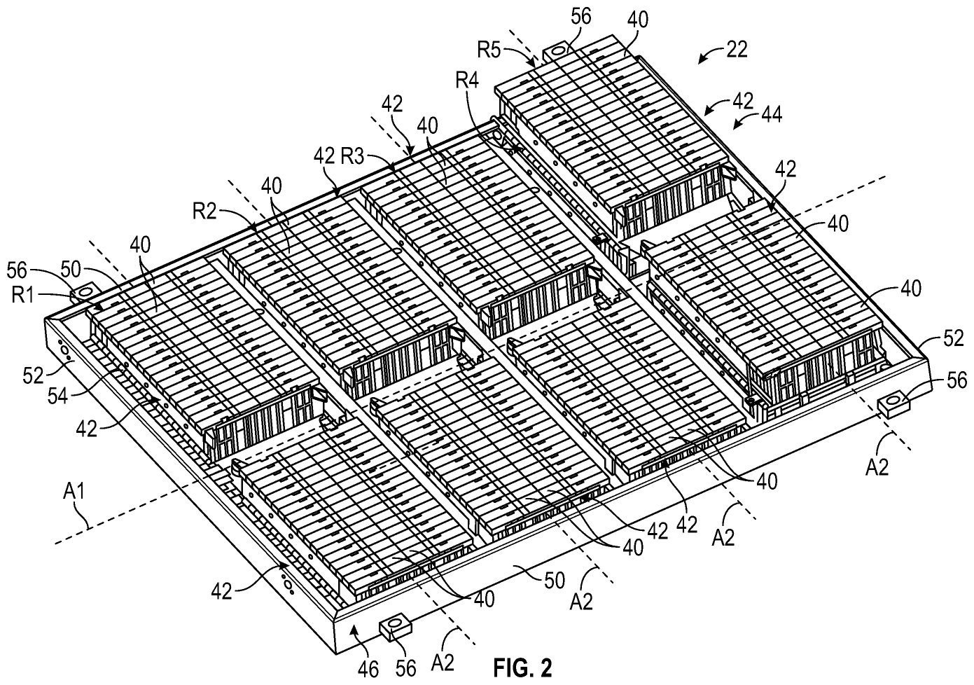

FIG. 2 illustrates a battery pack 22 that can be employed with an electrified vehicle, such as the electrified vehicle 20 of FIG. 1. The battery pack 22 may house a plurality of battery cells 40 that store energy for powering various electrical loads of the electrified vehicle 20. The battery pack 22 could employ any number of battery cells 40 within the scope of this disclosure.

The battery cells 40 may be stacked side-by-side to construct groupings of battery cells 40. The battery cells 40 of each grouping, along with any support structure (e.g., array frames, spacers, rails, walls, end plates, side plates, bindings, etc.), may collectively be referred to as a battery array 42. The battery pack 22 depicted in FIG. 2 includes four rows (labeled as rows R1, R2, R3, and R4) of two laterally adjacent battery arrays 42 for a total of eight battery arrays 42. An additional row R5 (e.g., a second tier) of two adjacent battery arrays 42 may be stacked on top of at least one of the R1-R4 (as illustrated, row R5 is stacked on top of row R4) for a total of ten battery arrays 42. However, the battery pack 22 could include a greater or fewer number of battery arrays 42 and still fall within the scope of this disclosure.

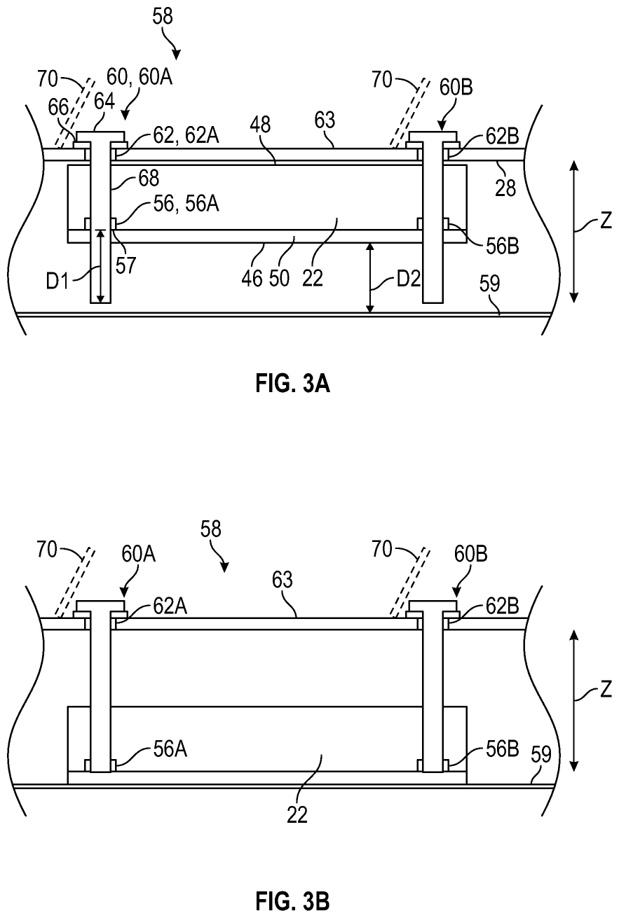

An enclosure assembly 44 may house each battery array 42 of the battery pack 22. The enclosure assembly 44 may extend along a central longitudinal axis A1 and may include a tray 46 and a cover 48 (shown in FIG. 3A). The enclosure assembly 44 may include any size, shape, and configuration within the scope of this disclosure. The tray 46 includes a pair of longitudinally extending side walls 50, a pair of laterally extending side walls 52, and a floor 54 disposed between the pair of longitudinally extending side walls 50 and the pair of laterally extending side walls 52. The longitudinally extending side walls 50 may extend in parallel with the central longitudinal axis A1, and the laterally extending side walls 52 may extend generally perpendicular to the central longitudinal axis A1. When mounted to the electrified vehicle 20, the longitudinally extending side walls 50 of the tray 46 may extend in parallel with a front-to-rear length of the electrified vehicle 20, and the laterally extending side walls 52 may extend in parallel with the cross-width of the electrified vehicle 20.

The battery pack 22 may further include a plurality of threaded holes 56. In an example, the threaded holes 56 are integral with the tray 46 and are disposed on or outside of the longitudinally extending side walls 50. In an example, each longitudinally extending side wall 50 includes two spaced apart threaded holes 56 for a total of four threaded holes 56 disposed toward each corner of the battery pack 22.

FIGS. 3A and 3B, with continued reference to FIGS. 1-2, illustrate a service tool assembly 58 for translating the battery back 22 between an installed position (FIG. 3A) and a lowered position (FIG. 3B) relative to electrified vehicle 20. Notably, the figures of this disclosure are not drawn to scale, and some components may be minimized or exaggerated in order to better emphasize certain features of the disclosure.

In the installed position, the battery pack 22 is proximate to the underbody 28 of the electrified vehicle 20 in a position where it may be connected to the electric machine 24 through the electrical harness 32 and connected to the coolant circuit 36 through coolant conduits 38. In the lowered position, the battery pack 22 is disconnected from the electrical harness 32 and coolant conduits 38 and may rest on a surface 59 under the electrified vehicle 20 where it may be serviced. In examples, the surface 59 may be a floor or grounds upon which the wheels 26 of the electrified vehicle 20 may rest. In other examples, the surface 59 is a pallet or other raised platform above the floor upon which the wheels 26 may rest.

The service tool assembly 58 includes service tools 60 inserted through access holes 62 in a floor 63 of the electrified vehicle 20 and received in the threaded holes 56 of the battery pack 22. The floor 63 may be a floor panel that establishes a boundary between the passenger compartment 25 and the underbody 28. The access holes 62 in the floor 63 may be vertically aligned with the threaded holes 56 of the battery pack 22. Each service tool 60 may include a head 64, a thrust bearing 66, and a threaded rod 68. The head 64 and the threaded rod 68 of the service tool 60 establish an integrated component. The head 64 may be a hex head. The threaded rod 68 may include threads with a diameter of at least ¼ inches, however other sizes may be appropriate within the scope of this disclosure.

The thrust bearing 66 may include an outer diameter larger than the diameter of the access holes 62 and may interface with the floor 63 on top of an access hole 62. The head 64 of the service tool 60 includes a diameter larger than an inner diameter of the thrust bearing 66 and sits on top of the thrust bearing 66. The threaded rod 68 may extend from the head 64, through the thrust bearing 66 and access hole 62 and may engage one of the threaded holes 56 of the battery pack 22.

In the installed position of FIG. 3A, the threaded rod 68 may extend a distance D1 beyond the bottom 57 of the threaded hole 56, but terminates prior to reaching surface 59. In examples, the distance D1 is greater than or equal to a distance D2 between the tray 46 and the surface 59 under the electrified vehicle 20 in the installed position.

The fasteners 30 that connect the battery pack 22 to the underbody 28 of the electrified vehicle 20 during normal operation may be removed in the installed position. With the fasteners 30 removed, the battery pack 22 is supported on the electrified vehicle 20 by the service tools 60 alone and the service tools 60 may bear the full weight of the battery pack 22.

The service tool 60 does not threadably engage the access hole 62 and therefore may rotate within the access hole 62 while the head 64 remains seated on thrust bearing 66. Thrust bearing 66 facilitates smooth rotation of the head 64 and threaded rod 68. Due to the threaded engagement between the threaded rod 68 of the service tool 60 and the threaded hole 56 of the battery pack 22, rotation of the threaded rod 68 causes the threaded hole 56 to translate along the threaded rod 68 in a Z-axis direction which extends in the height direction of the electrified vehicle 20. This, in turn, causes the battery pack 22 to translate relative to the electrified vehicle 20 between the installed position and the lowered position. Rotation of the service tool 60 in a first direction (i.e. clockwise or counterclockwise) moves the battery pack 22 from the installed position to the lowered position and rotation of the service tool 60 in an opposite direction to the first direction moves the battery pack 22 from the lowered position to the installed position. When the battery pack 22 is moved from the installed position to the lowered position it translates along the Z-axis towards the ground 59 and when the battery pack is moved from the lowered position to the installed position it translates along the Z-axis in an opposite direction towards the floor 63.

In some implementations, the service tool assembly 58 may include two front service tools 60A extending through two front access holes 62A and received in two front threaded holes 56A of the battery pack 22. The two front access holes 62A are each located towards opposed lateral sides of the electrified vehicle 20. Similarly, the service tool assembly 58 may include two rear service tools 60B extending through two rear access holes 62B and received in two rear threaded holes 56B of the battery pack. The two rear access holes 62B are each located towards opposed lateral sides of the electrified vehicle. Accordingly, there may be a total of four service tools 60 extending through the floor 63 of the electrified vehicle 20 and received in the threaded holes 56 of the battery pack 22. However, the service tool assembly 58 could include a greater or fewer number of service tools 60 within the scope of this disclosure.

In an example, all the access holes 62 of the service tool assembly 58 are located in the passenger compartment 25 of the electrified vehicle 20. The front access holes 62A may be positioned on the floor 63 in the foot space 29 of the front seats 27 (i.e., driver's seat and front passenger seat) of the passenger compartment 25. In an example, a front access hole 62A is positioned behind a dead pedal or footrest. The rear access holes 62B may be positioned under the row of rear seats 31 of the passenger compartment 25. An access cover 70 may cover the access hole 62 during normal operation and may prevent ingress of water and dust from outside the electrified vehicle 20 . The access cover 70 may be pivoted or removed so the access hole 62 can receive a service tool 60.

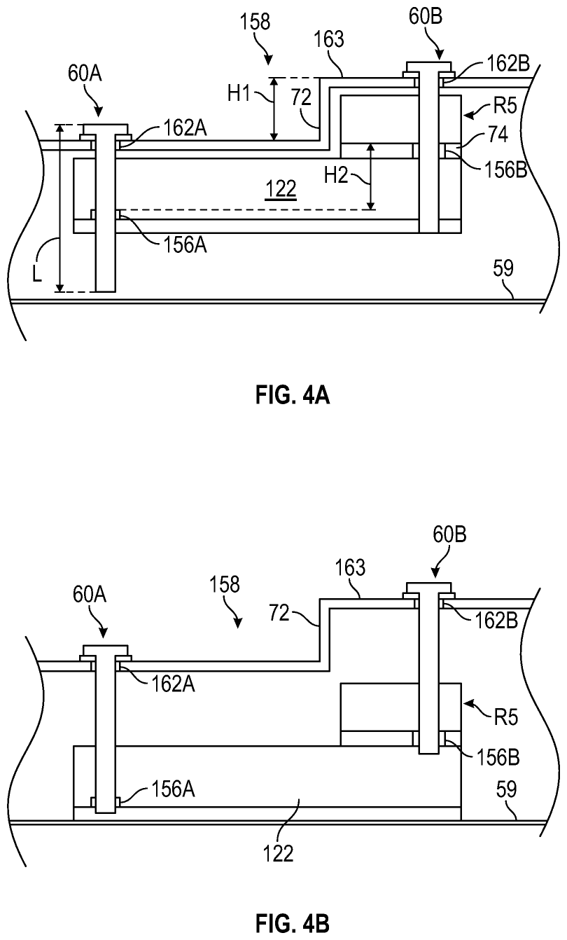

FIGS. 4A and 4B illustrate another example service tool assembly 158 for translating a battery pack 122 between an installed position (FIG. 4A) and a lowered position (FIG. 4B). In this disclosure, like reference numerals designate like elements where appropriate and reference numerals with the addition of one-hundred designate modified elements that are understood to incorporate the same features and benefits of the corresponding elements.

In the service tool assembly 158, a vehicle floor 163 is designed with a step 72 to accommodate a battery pack 122 including a second tier (e.g., row R5) of battery arrays 42. Due to the step 72, a rear access hole 162B may be at a height H1 above a front access hole 162A. Similarly, the battery pack 122 may include a rear threaded hole 156B at a height H2 above a front threaded hole 156A. In examples, the rear threaded hole 156B may be disposed on a second tier support structure 74 supporting the second tier row R5.

The height H1 between the access holes 162A, 162B may be less than or equal to the height H2 between the threaded holes 156A, 156B. Accordingly, a front service tool 60A extending through the front access hole 162A and threadably received in the front threaded hole 156A may include a length L that is the same as a rear service tool 60B extending through the rear access hole 162B and threadably received in the rear threaded hole 156B. Including threaded holes 156A, 156B at different heights on the battery pack enables uniform length L service tools 60 to lower the battery pack 122 to the surface 59 despite the non-planer vehicle floor 163.

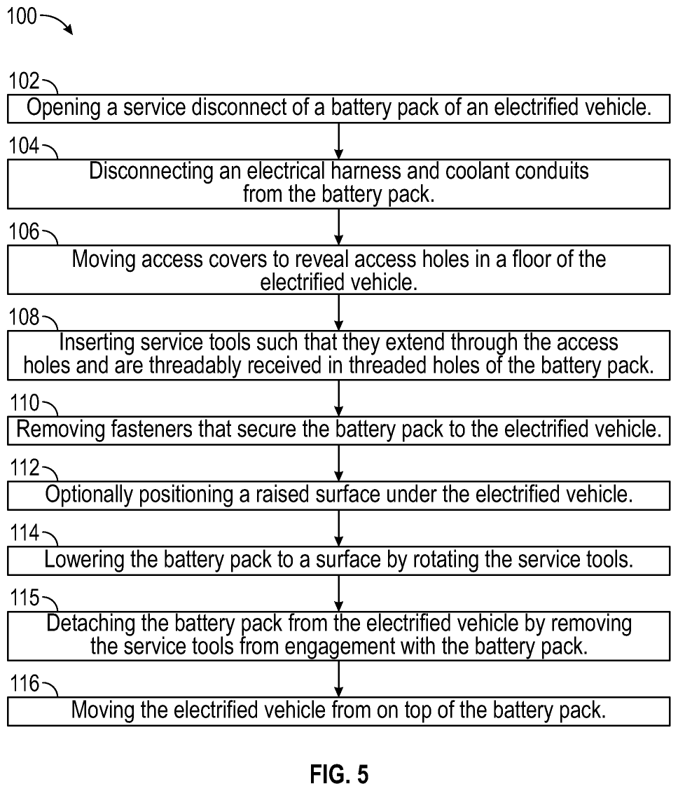

FIG. 5 illustrates an exemplary method of servicing the battery pack 22 from the electrified vehicle 20 using the service tool assembly 58. At step 102, the service disconnect 34 is opened. At step 104, the electrical harness 32 and coolant conduits 38 are disconnected from the battery pack 22. At step 106, access covers 70 are pivot or removed to reveal access holes 62 in the floor 63 of the electrified vehicle 60. At step 108, service tools 60 are inserted into the access holes 62 and threadably received by threaded holes 56 of the battery pack 22. Step 108 may include rotating the service tools 60 within the threaded holes 56 until the heads 64 of the service tools 60 sit on the floor 63. At step 110, mechanical fasteners 30 that secure the battery pack to the underbody 28 of the electrified vehicle 20 in operation are removed such that the battery pack 22 is supported on the electrified vehicle 20 by the service tools 60 alone. Step 110 may involve raising the vehicle with a vehicle hoist for easier removal of the mechanical fasteners and then lowering the vehicle.

At step 112, optionally, a pallet or other raised surface 59 may be positioned under the electrified vehicle 20 for receiving the battery pack 22. At step 114, the battery pack 22 is lowered to a surface 59 under the electrified vehicle 20 by rotating the service tools 60. Step 114 may include rotating the head 64 of the service tool 60 by hand with a tool, such as a wrench, for example. Step 114 may further include alternatingly rotating several service tools 60 in increments, a few turns at a time each, to keep the battery pack 22 level as it is lowered. At step 115, with the battery pack 22 resting on the surface 59, the battery pack 22 is detached from the electrified vehicle 20 by further rotating the service tools 60 until they are no longer in threaded engagement with the threaded holes 56. At step 116 the electrified vehicle 20 is moved from on top of the battery pack 22 to allow access to the battery pack 22 for servicing. Step 116 may involve hoisting the vehicle with a vehicle hoist or rolling the vehicle forward or backward.

Although method 100 is described with reference to service tool assembly 58 it is equally applicable to service tool assembly 158. Further, a battery pack 22, 122 may be raised and reinstalled on electrified vehicle 20 using the reverse procedure of method 100.

The disclosed service tool assemblies 58, 158 and method 100 allow a user to easily remove and reinstall a battery pack 22 of an electrified vehicle 20 for servicing. The disclosed examples do not require specialized equipment and may reduce overall service time for the electrified vehicle 20 and/or battery pack 22. A service tool 60 may be easier to produce and less expensive than current systems used to translate a battery pack 22 relative to an electrified vehicle 20.

The disclosed examples further allow same sized or uniform service tools 60 to be used throughout the service tool assembly 58, 158, regardless of a non-planer vehicle floor 63. Further, a uniform service tool 60 may be used for electrified vehicles 20 of different heights. If the threaded rod 68 of the service tool 60 is not long enough to deposit the battery pack 22 on the ground when used in vehicles with greater ground clearance, a pallet or other raised surface 59 may be placed under the vehicle to receive the battery pack 22. A uniform sized service tool 60 may reduce expenses associated with servicing multiple different electrified vehicles 20.

Although the different non-limiting embodiments are illustrates as having specific components or steps, the embodiments of this disclosure are not limited to those particular combinations. It is possible to use some of the components or features from any of the non-limiting embodiments in combination with features or components from any of the other non-limiting embodiments. In other words, placement and orientation of the various components of service tool assembly 58 are shown schematically and could vary within the scope of this disclosure.

The various figures accompanying this disclosure are not necessarily drawn to scale, and some features may be exaggerated or minimized to emphasize certain details of a particular component. It should be understood that like reference numerals identify corresponding or similar elements through the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A service tool assembly comprising:
a service tool extending through an access hole in a floor of an electrified vehicle and adapted to engage a threaded hole of a battery pack; and
wherein the service tool is rotatable to translate the battery pack relative to the electrified vehicle.

2. The service tool assembly of claim 1, wherein the service tool includes a head integral with a threaded rod, the head seated above the access hole and the threaded rod extending through the access hole and received in the threaded hole of the battery pack.

3. The service tool assembly of claim 2, wherein the service tool includes a thrust bearing, the thrust bearing sitting on the floor on top of the access hole, the head sitting on top of the thrust bearing, and the threaded rod extending through the thrust bearing.

4. The service tool assembly of claim 2, wherein the threaded rod extends a first distance past a bottom of the threaded hole, the first distance being greater than or equal to a second distance between the battery pack and a surface under the electrified vehicle.

5. The service tool assembly of claim 1, wherein the threaded hole is disposed on a longitudinally extending side wall of a tray of the battery pack.

6. The service tool assembly of claim 1, wherein the access hole is located in a passenger compartment of the electrified vehicle.

7. The service tool assembly of claim 6, wherein the access hole is located on the floor in a foot space of one of a driver's seat and a front passenger seat.

8. The service tool assembly of claim 6, wherein the access hole is located on the floor under a row of rear seats.

9. The service tool assembly of claim 1, further comprising a plurality of service tools extending through a plurality of access holes and received in a plurality of threaded holes of the battery pack.

10. The service tool assembly of claim 9, wherein the battery pack is supported on the electrified vehicle by the plurality of service tools alone.

11. The service tool assembly of claim 9, wherein the plurality of service tools include a uniform length.

12. The service tool assembly of claim 11, wherein the plurality of access holes include a first access hole at a first height above a second access hole, the plurality of threaded holes include a first threaded hole at a second height above a second threaded hole, and the first height is less than or equal to the second height.

13. A method of translating a battery pack relative to an electrified vehicle comprising:
inserting a service tool through an access hole of the electrified vehicle;
engaging a threaded hole of the battery pack with the service tool; and
rotating the service tool, thereby translating the battery pack relative to the electrified vehicle.

14. The method of claim 13, further comprising removing fasteners securing the battery pack to the electrified vehicle prior to translating. The method of claim 14, further comprising opening a service disconnect and detaching an electrical harness and coolant conduit from the battery pack prior to translating the battery pack.

16. The method of claim 13, further comprising moving an access cover covering the access hole prior to inserting the service tool.

17. The method of claim 13, wherein inserting the service tool includes inserting a plurality of service tools such that they extend through a plurality of access holes and are received in a plurality of threaded holes of the battery pack.

18. The method of claim 17, wherein translating the battery pack includes alternatingly rotating each of the plurality of service tools.

19. The method of claim 13, wherein translating the battery pack includes lowering the battery pack to rest on a surface, and further comprising removing the service tools from engagement with the battery pack after the step of translating.

20. The method of claim 13, wherein:
the access hole extends through a floor of the electrified vehicle;
the service tool includes a head, a threaded rod and a thrust bearing; and
the step of inserting includes inserting the service tool such that the thrust bearing sits on the floor above the access hole, the head sits on top of the thrust bearing, and the threaded rod extends through the thrust bearing and access hole and is received in the threaded hole.
